(19) United States
(12) Patent Application Publication
(10) Pub. No.: US 2026/0194637 A1
(43) Pub. Date: Jul. 9, 2026

(54) Light Detection and Ranging Devices with Reconfigurable Microcells

(71) Applicant: SEMICONDUCTOR COMPONENTS INDUSTRIES, LLC, Scottsdale, AZ (US)

(72) Inventors: Steven John BUCKLEY, Henlow (GB); Vincenzo SESTA, Cork (IE)

(73) Assignee: SEMICONDUCTOR COMPONENTS INDUSTRIES, LLC, Scottsdale, AZ (US)

(21) Appl. No.: 19/013,984

(22) Filed: Jan. 8, 2025

(51) Int. Cl. G01S 7/4863; G01S 7/4865; G01S 7/487; G01S 17/894; G01S 17/931

(52) U.S. Cl. CPC G01S 7/4863; G01S 7/4865; G01S 7/4873; G01S 17/894; G01S 17/931

(57) ABSTRACT

A light detection and ranging (LIDAR) system may include a laser and a sensor array, such as an array of single photon avalanche diode (SPAD) microcells that produce signals in response to laser light that reflects off a target scene. The LIDAR system may be a direct time-of-flight system that is operated in a rolling shutter mode in which a line of light is emitted toward the scene. A reflected line of light reflects from the scene and may be measured by the array of microcells. The microcells may be grouped in macropixels, which may be activated in reconfigurable columns to measure the reflected line of light. In particular, the line of light may be distorted by optics in the LIDAR system and/or a distance to the target scene, and the reconfigurable columns may be activated to coincide with the distorted line of light.

### BACKGROUND

This relates generally to imaging systems, and more specifically, to LIDAR (light detection and ranging) based imaging systems.

Conventional LIDAR imaging systems illuminate a target with light (typically a coherent laser pulse) and measure the return time of reflections off the target to determine a distance to the target and light intensity to generate three-dimensional images of a scene. The LIDAR imaging systems include direct time-of-flight circuitry and lasers that illuminate a target. The time-of-flight circuitry may determine the flight time of laser pulses (e.g., having been reflected by the target), and thereby determine the distance to the target. In direct time-of-flight LIDAR systems, this distance is determined for each pixel in an array of single-photon avalanche diode (SPAD) pixels that form an image sensor.

In LIDAR systems operated in a rolling shutter mode, a light source (e.g., a laser) produces a continuous scanning line that coincides with a row or column of the image sensor, and the light source moves the line across a field of view that coincides with the total number of rows or columns of the image sensor. However, due to optics in the light source and/or the image sensor, the line may be distorted, reducing the signal-to-noise ratio (SNR) of the LIDAR system and/or increasing the power requirements of the light source.

### BRIEF DESCRIPTION OF THE DRAWINGS

FIG. 1 is a schematic diagram of an illustrative system that includes a LIDAR imaging system in accordance with some embodiments.

FIG. 2 is a circuit diagram showing an illustrative single-photon avalanche diode (SPAD) pixel in accordance with some embodiments.

FIG. 3 is a diagram of an illustrative LIDAR system measuring a depth of a target scene in accordance with some embodiments.

FIG. 4 is a diagram of an illustrative sensor array for a LIDAR system measuring a line of light in a rolling shutter mode in accordance with some embodiments.

FIGS. 5A and 5B are diagrams of an illustrative sensor array with reconfigurable columns of macropixels to measure distorted lines of light in a rolling shutter mode in accordance with some embodiments.

FIG. 6 is a diagram of an illustrative sensor array with reconfigurable columns of macropixels in accordance with some embodiments.

FIG. 7 is a diagram of an illustrative multiplexer and coincidence circuit that may be coupled to a macropixel in accordance with some embodiments.

FIG. 8 is a diagram of an illustrative coincidence circuit in accordance with some embodiments.

### DETAILED DESCRIPTION

Embodiments herein relate to LIDAR systems having direct time-of-flight capabilities.

Some imaging systems include image sensors that sense light by converting impinging photons into charge carriers (electrons and holes) that are integrated (collected) in pixel photodiodes within the sensor array. After completion of an integration cycle, collected charge is converted into a voltage, which is supplied to the output terminals of the sensor. In complementary metal-oxide semiconductor (CMOS) image sensors, the charge to voltage conversion is accomplished directly in the pixels themselves and the analog pixel voltage is transferred to the output terminals through various pixel addressing and scanning schemes. The analog pixel voltage can also be later converted on-chip to a digital equivalent and processed in various ways in the digital domain.

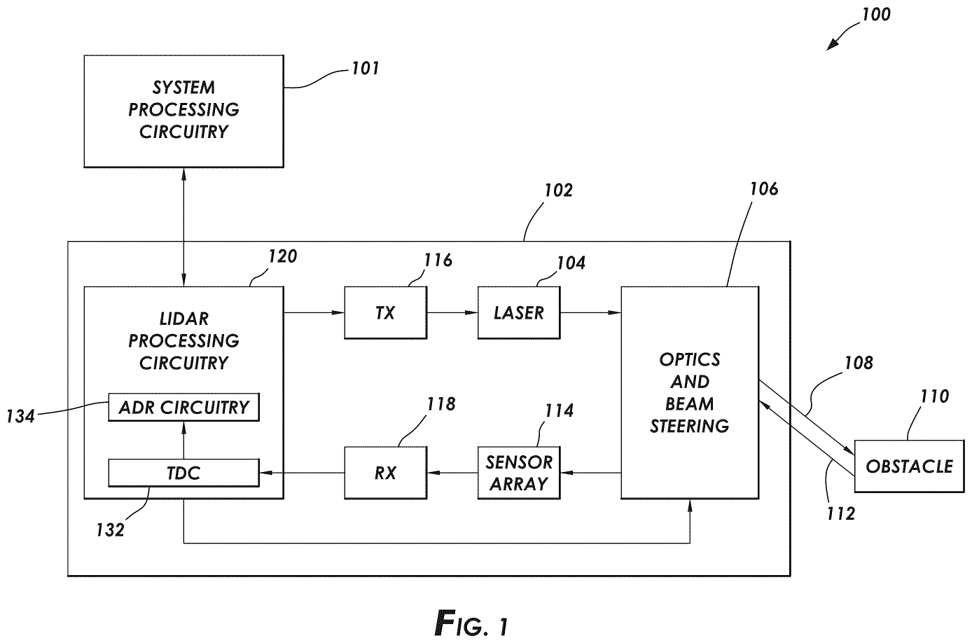

In light detection and ranging (LIDAR) devices, such as the ones described in connection with FIG. 1, on the other hand, the photon detection principle is different. LIDAR devices may include a light source, such as a laser, that emits light toward a target object/scene. Each light sensing diode in the LIDAR devices may be biased slightly above its breakdown point and when an incident photon from the laser, such as light that has reflected off of the target object/scene, generates charge carriers (an electron and a hole), these carriers initiate an avalanche breakdown with additional carriers being generated. The avalanche multiplication may produce a current signal that can be easily detected by readout circuitry associated with single-photon avalanche diode (SPAD). The avalanche process needs to be stopped (quenched) by lowering the diode bias below its breakdown point.

In LIDAR devices, SPAD pixels may be used to measure photon time-of-flight (ToF) from a synchronized light source to a scene object point and back to the sensor, which can be used to obtain a 3-dimensional image (e.g., depth measurement) of the scene. This method requires time-to-digital conversion circuitry to determine an amount of time that has elapsed since the laser light has been emitted and thereby determine a distance to the target object.

In LIDAR systems operated in a rolling shutter mode, the light source produces a continuous scanning line that coincides with a row or column of the sensor, and the light source moves the line across an entire field of view that coincides with the total number of rows or columns of the sensor. However, due to optics in the light source and/or the image sensor, the line may be distorted, reducing the signal-to-noise ratio (SNR) of the LIDAR system and/or increasing the power requirements of the light source. Therefore, the rows/columns of the sensor may be reconfigurable to match the distorted line, thereby increasing the SNR and reducing the power requirements.

FIG. 1 is a schematic diagram of an illustrative system that includes a LIDAR imaging system. System 100 of FIG. 1 may be vehicle system, such as an active braking system or other vehicle safety system, a surveillance system, a medical imaging system, a general machine vision system, or any other desired type of system.

System 100 includes a LIDAR-based system 102, such as a LIDAR imaging system, sometimes referred to as a LIDAR module, a LIDAR system, or a LIDAR device. LIDAR module 102 may be used to capture images of a scene and/or measure distances to obstacles (also referred to as targets) in the scene. For example, LIDAR module 102 may measure the depth across the scene.

As an example, in a vehicle safety system, information from LIDAR module 102 may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane-drift avoidance system), or a pedestrian detection system. In at least some instances, a LIDAR module (e.g., LIDAR module 102) may form part of a semi-autonomous or autonomous self-driving vehicle.

LIDAR module 102 may include laser 104 (or other suitable light source) that emits light 108 to illuminate obstacle 110 (also referred to as a target, scene, and/or object herein). Laser 104 may emit light 108 at any desired wavelength, such as infrared light or visible light. Optics and beam-steering equipment 106 may overlap laser 104 and may be used to direct the light beam from laser 104 toward obstacle 110. Light 108 may illuminate obstacle 110 and return to LIDAR module 102 as reflected light 112. One or more lenses in optics and beam-steering 106 may overlap sensor array 114 and may focus reflected light 112 onto sensor array 114.

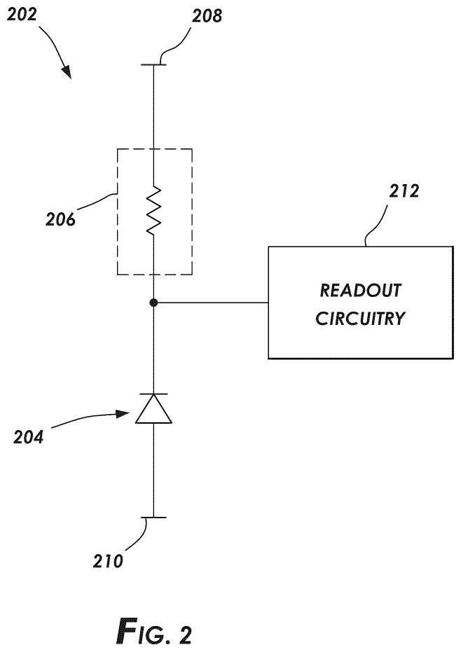

Sensor array 114 may be, for example, an array of SPADs or an array of other suitable sensors. In other words, sensor array 114 may include a plurality of SPADs, arranged in an array (e.g., a one-dimensional array or a two-dimensional array. In SPAD devices, the light sensing diode is biased above its breakdown point. When an incident photon generates a pair of charge carriers (an electron and a hole), these carriers initiate an avalanche breakdown with additional carriers being generated. The avalanche multiplication may produce a current signal that can be detected by readout circuitry associated with the SPAD. The avalanche process can be stopped (quenched) by lowering the diode bias below its breakdown point. Each SPAD may therefore include a passive and/or active quenching circuit for halting the avalanche. The SPAD pixels may be used to measure photon ToF from a synchronized light source, such as laser 104, to a scene object point and back to the sensor, which can be used to obtain a 3-dimensional image of the scene. An illustrative example of a SPAD pixel that may be used in sensor array 114 is shown in FIG. 2.

As shown in FIG. 2, SPAD device 202 includes SPAD 204 that is coupled in series with quenching circuitry 206 between a first supply voltage terminal 208, which may be a ground power supply voltage terminal, for example, and a second supply voltage terminal 210, which may be a power supply voltage terminal, for example. During the operation of SPAD device 202, supply voltage terminals 208 and 210 may be used to bias SPAD 204 to a voltage that is higher than the breakdown voltage. Breakdown voltage is the largest reverse voltage that can be applied without causing an exponential increase in the leakage current in the diode. When SPAD 204 is biased above the breakdown voltage in this manner, absorption of a single-photon can trigger a short-duration but relatively large avalanche current through impact ionization.

Quenching circuitry 206 (sometimes referred to as quenching element 206) may be used to lower the bias voltage of SPAD 204 below the level of the breakdown voltage. Lowering the bias voltage of SPAD 204 below the breakdown voltage stops the avalanche process and corresponding avalanche current. There are numerous ways to form quenching circuitry 206. Quenching circuitry 206 may be passive quenching circuitry or active quenching circuitry. Passive quenching circuitry may automatically quench the avalanche current without external control or monitoring once initiated. For example, FIG. 2 shows an example where a resistor is used to form quenching circuitry 206. This is an example of passive quenching circuitry. After the avalanche is initiated, the resulting current rapidly discharges the capacity of the device, lowering the voltage at the SPAD to near to the breakdown voltage. The resistance associated with the resistor in quenching circuitry 206 may result in the final current being lower than required to sustain itself. The SPAD may then be reset to above the breakdown voltage to enable detection of another photon.

This example of passive quenching circuitry is merely illustrative. Active quenching circuitry may also be used in SPAD device 202. Active quenching circuitry may reduce the time it takes for SPAD device 202 to be reset. This may allow SPAD device 202 to detect incident light at a faster rate than when passive quenching circuitry is used, improving the dynamic range of the SPAD device. Active quenching circuitry may modulate the SPAD quench resistance. For example, before a photon is detected, quench resistance is set high and then once a photon is detected and the avalanche is quenched, quench resistance is minimized to reduce recovery time.

SPAD device 202 may also include readout circuitry 212. There are numerous ways to form readout circuitry 212 to obtain information from SPAD device 202. Readout circuitry 212 may include a pulse counting circuit that counts arriving photons. Alternatively or additionally, readout circuitry 212 may include ToF circuitry that is used to measure photon ToF. The photon ToF information may be used to perform depth sensing.

In one example, photons may be counted by an analog counter to form a light intensity signal as a corresponding pixel voltage. In other words, the pixel voltage may correspond to the light intensity on the SPAD device. The ToF signal may be obtained by also converting the time of photon flight to a voltage. The example of an analog pulse counting circuit being included in readout circuitry 212 is merely illustrative. If desired, readout circuitry 212 may include digital pulse counting circuits. Readout circuitry 212 may also include amplification circuitry if desired.

The example in FIG. 2 of readout circuitry 212 being coupled to a node between SPAD 204 and quenching circuitry 206 is merely illustrative. Readout circuitry 212 may be coupled to any desired portion of the SPAD device. In some cases, quenching circuitry 206 may be considered integral with readout circuitry 212.

Because SPAD devices can detect a single incident photon, the SPAD devices are effective at imaging scenes with low light levels. Each SPAD may detect how many photons are received within a given period of time, such as by using readout circuitry that includes a counting circuit. However, as discussed above, each time a photon is received and an avalanche current initiated, the SPAD device must be quenched and reset before being ready to detect another photon. As incident light levels increase, the reset time becomes limiting to the dynamic range of the SPAD device. In particular, once incident light levels exceed a given level, the SPAD device is triggered immediately upon being reset. Moreover, the SPAD devices may be used in a LIDAR system to determine when light has returned after being reflected from an external object.

Therefore, multiple SPAD devices may be used in an array, such as sensor array 114. If desired, each SPAD pixel may have individual readout circuitry within sensor array 114, or readout circuitry may be shared between SPAD pixels. Each SPAD pixel is not guaranteed to have an avalanche current triggered when an incident photon is received. The SPAD pixels may have an associated probability of an avalanche current being triggered when an incident photon is received. There is a first probability of an electron being created when a photon reaches the diode and then a second probability of the electron triggering an avalanche current. The total probability of a photon triggering an avalanche current may be referred to as the SPAD's photon-detection efficiency (PDE).

The sensor array (e.g., sensor array 114 of FIG. 1) can detect photon flux at a single point. It may be desirable to use SPAD pixels to obtain image data across an array to allow a higher resolution reproduction of the imaged scene. In cases such as these, SPAD pixels in a single imaging system may have per-pixel readout capabilities. Alternatively, an array of sensor arrays, each including more than one SPAD pixel, may be included in the imaging system. The outputs from each pixel or from each sensor array may be used to generate image data for an imaged scene. The array may be capable of independent detection, whether using a single SPAD pixel or a plurality of SPAD pixels in a sensor array, in a line array, such as an array having a single row and multiple columns or a single column and multiple rows or an array having more than ten, more than one hundred, or more than one thousand rows and/or columns.

Returning to FIG. 1, LIDAR module 102 may also include a transmitter 116 and receiver 118. LIDAR processing circuitry 120 may control transmitter 116 and laser 104. LIDAR processing circuitry 120 may include processing circuitry and storage and may be configured to perform operations using hardware, such as dedicated hardware or circuitry, firmware and/or software. Software code for performing operations and other data may be stored on non-transitory computer readable storage media, such as tangible computer readable storage media, in the processing circuitry. Remote storage and other remote-control circuitry, such as circuitry on remote servers, may also be used in storing the software code. The software code may sometimes be referred to as software, data, program instructions, computer instructions, instructions, or code. The non-transitory computer readable storage media may include non-volatile memory such as non-volatile random-access memory, one or more hard drives, such as magnetic drives or solid-state drives, one or more removable flash drives or other removable media, or other storage. Software stored on the non-transitory computer readable storage media may be executed on the processing circuitry and/or the processing circuitry of remote hardware such as processors associated with one or more remote servers that communicate over wired and/or wireless communications links. The processing circuitry may include application-specific integrated circuits with processing circuitry, one or more microprocessors, a central processing unit (CPU) or other processing circuitry.

LIDAR processing circuitry 120 may also receive data from receiver 118 and sensor array 114. Based on the data from sensor array 114, LIDAR processing circuitry 120 may determine a distance to the obstacle 110. The LIDAR processing circuitry 120 may communicate with system processing circuitry 101. System processing circuitry 101 may take corresponding action, such as on a system-level, based on the information from LIDAR module 102.

LIDAR processing circuitry 120 may include time-to-digital converter (TDC) circuitry 132 and autonomous dynamic resolution (ADR) circuitry 134. The time-to-digital converter circuitry 132 may use time values, such as the time between the laser emitting light and the reflection being received by sensor array 114, to obtain a digital value representative of the distance to the obstacle 110.

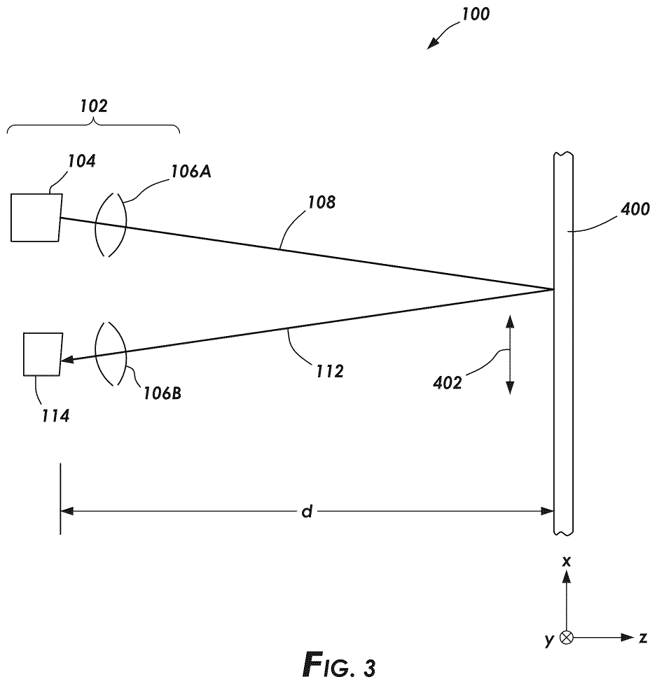

In some embodiments, sensor array 114 of LIDAR system 102 may be formed from an array of SPAD pixels or SPAD devices (also referred to as microcells and/or SPAD microcells herein), such as SPAD pixels 202 of FIGS. 2 and 3. The array of SPAD pixels may be a one-dimensional array of SPAD pixels or a two-dimensional array of SPAD pixels. For example, the array of SPAD pixels may be a two-dimensional array of SPAD pixels arranged in rows and columns.

In operation, LIDAR system 102 may be operated in a rolling shutter mode. In particular, LASER 104 may emit light 108 in a line that corresponds to columns (or rows) of the array of SPAD pixels. Optics and beam steering 106 may steer the line of light 108 across a scene, such as a scene that includes obstacle 110 (FIG. 1), to move across all of the columns (or rows) of the array of SPAD pixels. An illustrative example is shown in FIG. 3.

As shown in FIG. 3, laser 104 may emit light 108 through optics 106A toward scene 400 (also referred to as target 400 and external object 400 herein). The light may reflect off of scene 400 as light 112. Light 112 may pass through optics 106B and be received by sensor array 114, which may be an array of SPAD microcells, such multiple SPAD pixels 202 of FIG. 2.

In a rolling shutter mode, light 108 may be emitted in a line, such as a line that extends in the X-Y direction of FIG. 3. The line of light 108 may correspond with a column (or row) of SPAD pixels in the array of SPAD pixels of sensor array 114. The line of light 108 may be moved across scene 400, such as in one or both directions 402 (e.g., in the +X and/or −X direction), and the SPAD pixels of sensor array 114 may produce measurements in response to the light of light 108. In particular, the line of light may be moved across an entire field of view that coincides with the total number of rows or columns of the array of microcells in sensor array 114. By measuring the ToF of light 108 across scene 400, depth d across scene 400 may be determined.

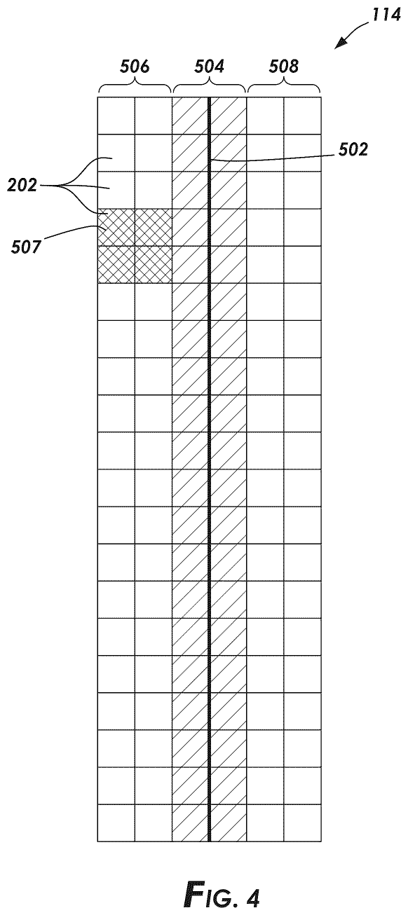

Ideally, the line of light 108 is a vertical line to coincide with the vertical columns of the array of pixels in sensor array 114. As shown in the illustrative example of FIG. 4, in an ideal setting, sensor array 114 would receive vertical line 502 of light (e.g., light 112 of FIG. 3).

Microcells 202 may form/be arranged in macropixels 507. In the example of FIG. 4, each macropixel 507 may include four microcells 202 (e.g., in a 2×2 configuration) and may output a single signal based on the signals generated by the corresponding microcells 202 (e.g., in response to light incident on microcells 202). In other words, the microcells 202 of a given macropixel 507 may have a shared output circuit. However, this is merely illustrative. In general, each macropixel 507 may include any suitable number of microcells, such as nine microcells (e.g., in a 3×3 configuration), 16 microcells (e.g., in a 4×4 configuration), or other suitable number of microcells. Alternatively, each microcell 202 may have an individual output, and macropixels 507 may be omitted.

Line 502 may correspond with a column 504 of macropixels 507 (e.g., the shaded region of FIG. 4). When line 502 is incident on column 504 of macropixels 507, the macropixels in column 504 may be activated, while the other macropixels of the array may be deactivated. In other words, the other macropixels in columns 506 and 508 may not be detecting incident photons.

As the line of light 108 (FIG. 3) is moved across scene 400, line 502 may move across the array of macropixels in sensor array 114. In the illustrative example of FIG. 4, as the line of light moves across the scene, line 502 may move across an entirety of sensor array 114, such as across positions that correspond with columns 506 and 508 of macropixels 507. When line 502 is incident on a given column (e.g., column 504, 506, or 508) of macropixels, the macropixels in the given column may be activated, while the remaining macropixels in sensor array 114 may be deactivated. In this way, the depth of the scene may be determined across the field of view of sensor array 114 using a rolling shutter mode.

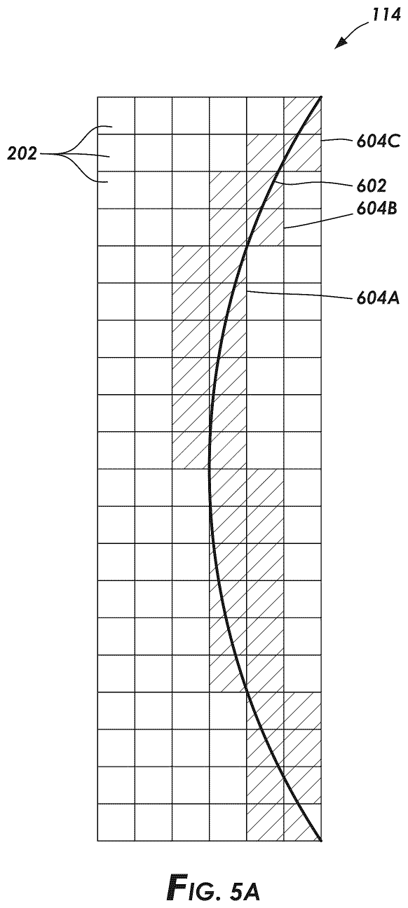

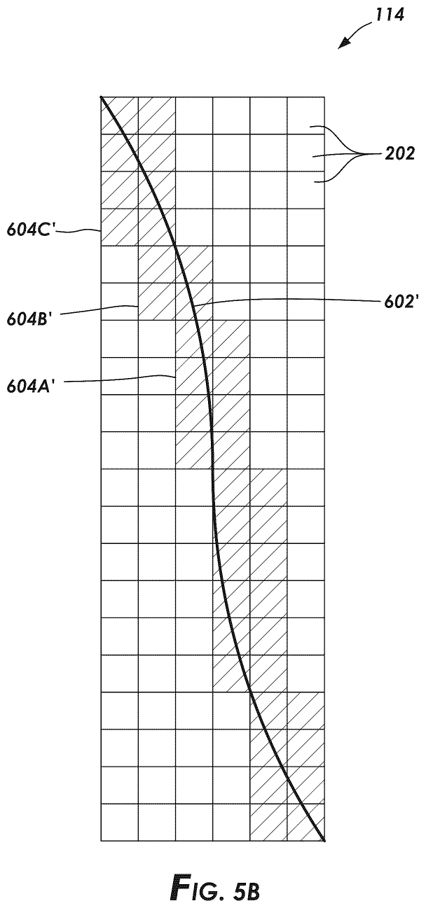

Although line 502 is ideally vertical, the line of light reflected on sensor array 114 may be distorted due to the characteristics of optics 106 (FIG. 3). Therefore, the macropixels and/or microcells of sensor array 114 may be reconfigurable to detect distorted lines of light that are reflected to sensor array 114. Illustrative examples are shown in FIGS. 5A and 5B.

As shown in FIG. 5A, line of light 602 received by sensor array 114 is not vertical. In other words, line 602 has been distorted by the optics (e.g., optics 106 of FIG. 3) associated with the light source and/or sensor array 114.

To compensate for the distortion of line 602, the microcells of sensor array 114 may be reconfigured. For example, as shown in the example of FIG. 5A, macropixels 604 of a given active column of sensor array 114 may be adjusted to detect line 602. In particular, macropixel 604A may be in the same position as the macropixels in column 504 of FIG. 4, while macropixels 604B and 604C may be shifted. Macropixel 604B may be shifted by a single microcell relative to macropixel 604A, and macropixel 604C may be shifted by two microcells (e.g., one macropixel) relative to macropixel 604A. In this way, the columns of microcells and/or macropixels of sensor array 114 may be reconfigurable.

By activating macropixels 604A, 604B, and 604C, along with the other shaded macropixels in FIG. 5A, to follow the shape of line 602, line 602 may be detected more accurately, and the SNR of sensor array 114 may be increased.

The example of FIG. 5A, in which macropixel 604B is shifted by a single microcell relative to macropixel 604A and macropixel 604C is shifted by a macropixel relative to macropixel 604A, is merely illustrative. In general, macropixels and/or microcells of sensor array 114 may be shifted by any suitable distance within sensor array 114 to coincide with the distortion of the line of light incident on sensor array 114. For example, in the illustrative embodiment of FIG. 5B, the line of light may be distorted to position 602′. To coincide with the line of light in position 602′, macropixel 604B′ may be shifted by one microcell relative to macropixel 604A in the opposite direction of the direction in FIG. 5A, and macropixel 604C′ may be shifted by one macropixel relative to macropixel 604A in the opposite direction of the direction in FIG. 5A.

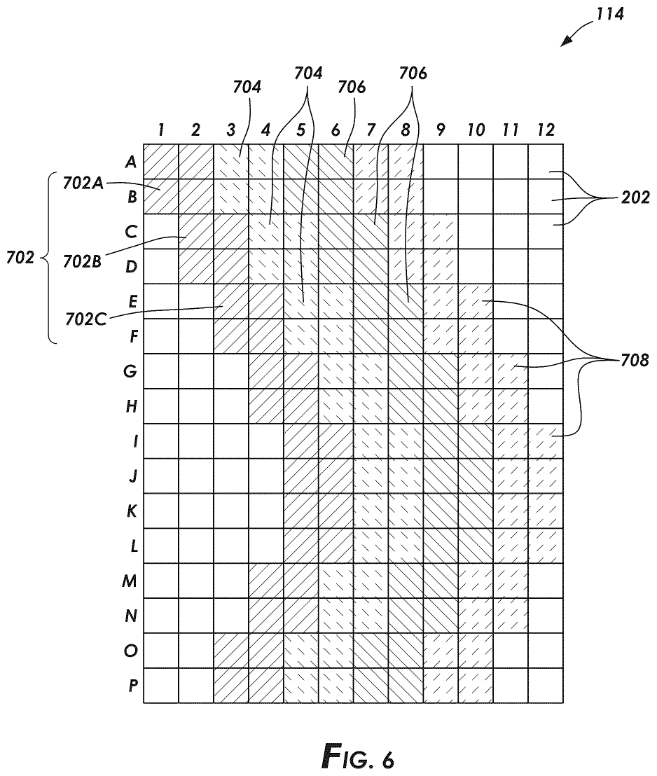

By shifting the active macropixels and/or microcells active at any given time in a rolling shutter mode, the SNR of sensor array 114 may be increased and/or the power requirements of the light source may be decreased. The active macropixels may be reconfigured in response to measurements by sensor array 114, in response to measurements from other sensors in the system that includes sensor array 114, and/or based on the known distortion provided by the optics in the LIDAR system and the distance to the external scene/object to be detected, as examples. An illustrative example of a sensor array with reconfigurable active macropixels and/or microcells is shown in FIG. 6.

As shown in FIG. 6, sensor array 114 may include an array of microcells 202. For reference, microcells 202 are labeled in FIG. 6 as pixel rows A-P and pixel columns 1-12. In the illustrative example of FIG. 6, sensor array 114 includes macropixels 702, 704, 706, and 708. Each macropixel 702, 704, 706, and 708 includes four microcells 202 in a 2×2 configuration.

A first column formed by macropixels 702 may be activated first. As shown, a first macropixel 702A may include first microcell A1, second microcell A2, third microcell B1,and fourth microcell B2. Second macropixel 702B may be shifted laterally relative to first macropixel 702A and may include first microcell C2, second microcell C3, third microcell D2,and fourth microcell D3. Similarly, third macropixel 702C may be shifted laterally relative to second macropixel 702A and may include first microcell E3, second microcell E4, third microcell F3, and fourth microcell F4.

In general, each macropixel 702 (e.g., in the first column of sensor array 114) may include activated microcells in columns 1 and 2, in columns 2 and 3, in columns 3 and 4, in columns 4 and 5, or in columns 5 and 6 to allow sufficient space for the remaining three columns of macropixels. In other words, macropixels 702 may be adjusted at a microcell level to form a column with a shape that coincides with the distorted line of light detected by sensor array (as discussed in connection with FIGS. 4 and 5).

Each of the following columns may have the same shapes as the first column, offset by one macropixel, if desired. In particular, macropixels 704 may be formed adjacent to macropixels 702. In general, each macropixel 704 (e.g., the second column of sensor array 114) may have microcells in columns 3 and 4, 4 and 5, 5 and 6, 6 and 7, or 7 and 8. This may be continued for the remaining columns. Each macropixel 706 (e.g., the third column of sensor array 114) may have microcells in columns 5 and 6, 6 and 7, 7 and 8, 8 and 9, or 9 and 10. Each macropixel 708 (e.g., the fourth column of sensor array 114) may have microcells in columns 7 and 8, 8 and 9, 9 and 10, 10 and 11, or 11 and 12. In this way, each column of active macropixels may be adjusted to have a shape that coincides with the distorted line of light measured by sensor array 114 in the rolling shutter mode.

The example of FIG. 6 in which sensor array 114 has 12 columns and 16 rows is merely illustrative. In general, sensor array 114 may have any suitable number of columns and rows of microcells. As examples, sensor array 114 may have at least 8 columns, at least 10 columns, at least 16 columns, or at least 24 columns, and may have at least 12 rows, at least 18 rows, at least 24 rows, or at least 36 rows. In general, regardless of the size of sensor array 114, columns of individual microcells or macropixels formed from any suitable number of microcells may be activated in any suitable shape, and the columns may be adjustable at a microcell-level. For example, each activated macropixel may be movable by a single microcell. Each activated macropixel may be moved to any suitable position within sensor array 114. In this way, the columns of activated macropixels in sensor array 114 may be adjusted to coincide with distorted light on sensor array 114.

Moreover, although the example of FIG. 6 shows each column of activated macropixels in sensor array 114 having the same shape, this is merely illustrative. Each column of activated macropixels may be reconfigured individually to have any suitable shape, if desired.

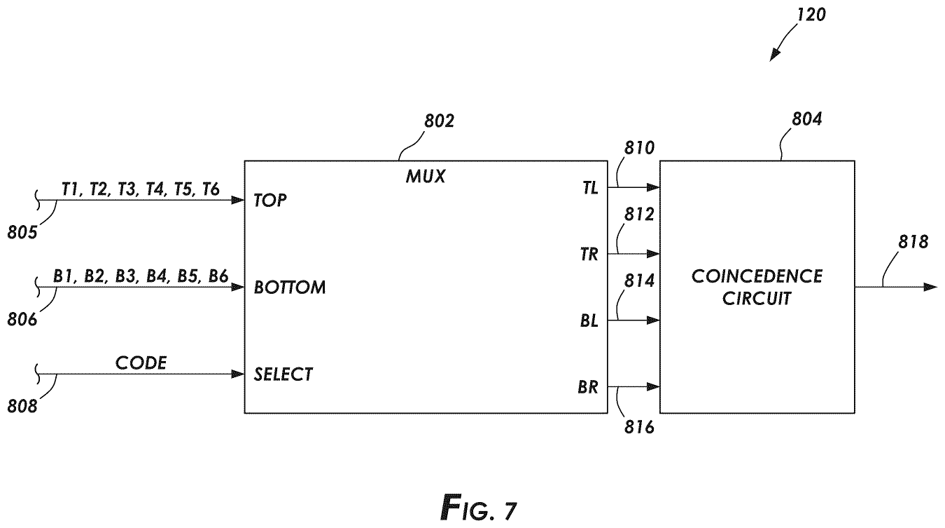

Regardless of the size of a sensor array with reconfigurable microcells and/or the size of the reconfigurable microcells/macropixels, the associated LIDAR system may include circuitry that allows for the sensor array to be reconfigured. An illustrative example is shown in FIG. 7.

As shown in FIG. 7, processing circuitry 120 may include multiplexer (MUX) 802 and coincidence circuit 804. Each reconfigurable portion of the sensor array (e.g., each macropixel of four microcells in the example of FIG. 6) may have an associated MUX 802 and coincidence circuit 804.

MUX 802 may take as inputs top input 805 that includes each of the possible activated microcell locations for the top of the macropixel, bottom input 806 that includes each of the possible activated microcell locations for the bottom of the macropixel, and select input 808 that include a code to indicate the position of the macropixel in the sensor array. For example, as described in the example of FIG. 6, each macropixels may include two activated microcells and may be moved across six columns of microcells. Therefore, top input 805 may include six microcell locations T1, T2, T3, T4, T5, and T6, and bottom input 806 may include six microcell locations B1, B2, B3, B4, B5, and B6. In the illustrative example of FIG. 6, macropixel 702A may have top input 805 that includes microcell locations A1, A2, A3, A4, A5,and A6 and bottom input 806 that includes microcell locations B1, B2, B3, B4, B5, and B6. Macropixel 702B may have top input 805 that includes microcell locations C1-C6 and bottom input 806 that includes microcell locations D1-D6. This pattern may continue for each of macropixels 702 in the first column, as well as the macropixels in the successive columns of sensor array 114.

Select input 808 may include a code that indicates the desired position of the associated macropixel in the sensor array. For example, in the example of FIG. 6, select input 808 may be a code between 0 and 4 that indicates which of the five possible positions should be used for the given macropixel. For macropixel 702A, for example, if select input 808 is 0, macropixel 702A may be positioned in columns 1 and 2; if select input 808 is 1, macropixel 702A may be positioned in columns 2 and 3; if select input 808 is 2, macropixel 702A may be positioned in columns 3 and 4; if select input 808 is 3, macropixel 702A may be positioned in columns 4 and 5; and if select input 808 is 4, macropixel 702A may be positioned in columns 5 and 6. In this way, select input 808 may be used to position each macropixel in the sensor array.

MUX 802 may multiplex top input 805, bottom input 806, and select input 808 into outputs 810, 812, 814, and 816, which may correspond with the top left microcell of the macropixel, the top right microcell of the macropixel, the bottom left microcell of the macropixel, and the bottom right microcell of the macropixel, respectively.

MUX 802 may reconfigure the active macropixels (e.g., the code input to MUX 802 may be adjusted) in response to measurements by sensor array 114, in response to measurements from other sensors in the system that includes sensor array 114, and/or based on the known distortion provided by the optics (e.g., the optics that overlap the light source and sensor array 114) in the LIDAR system and the distance to the external scene/object to be detected, as examples.

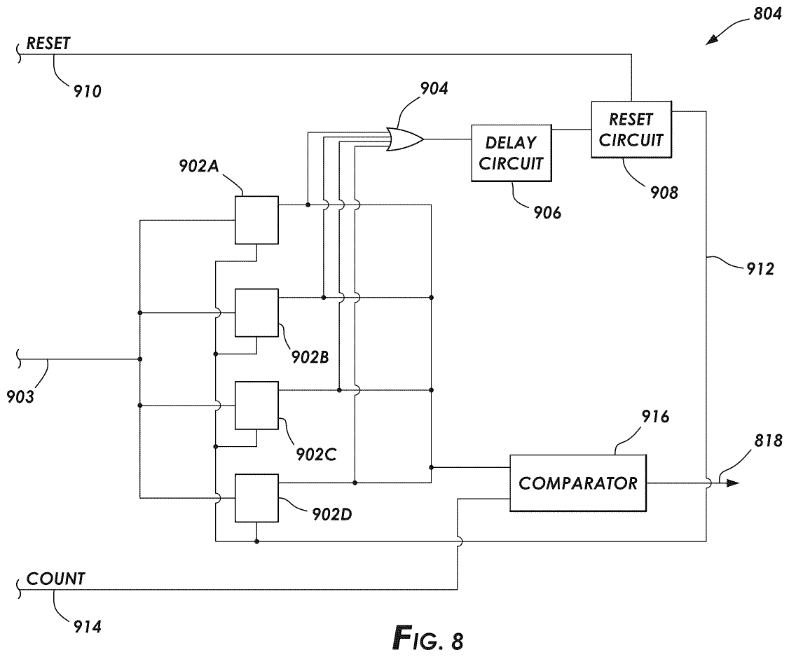

Outputs 810, 812, 814, and 816 may be passed to coincidence circuit 804, which may monitor each of the microcells in the respective macropixel to determine whether the microcells have detected incident light over a given window of time. Based on this determination, coincidence circuit 804 may provide output 818, which may indicate whether the macropixel has been activated (e.g., an output of 1) or has not been activated (e.g., an output of 0). An illustrative example of a coincidence circuit is shown in FIG. 8.

As shown in FIG. 8, coincidence circuit 804 may include flip flops 902, which may receive the outputs of the microcells of the macropixel associated with coincidence circuit 804. Outputs of flip flops 902 may be coupled to OR gate 904 and comparator 916. OR gate 904 may be coupled to delay circuit 906, which in turn may be coupled to reset circuit 908. Reset circuit 908 may be coupled to each flip flop 902 via output line 912.

In operation, each microcell coupled to flip flops 902A, 902B, 902C, and 902D may generate output 903 in response to light, which may be a line of light that has reflected from a scene. If any one of microcells detects light, the output of the associated flip flop 902 will be 1, and the output of OR gate 904 will be 1. Delay circuit 906 will then start an event window, such as a window of less than 100 ns, at least 50 ns, between 75 ns and 150 ns, or another suitable window. At the end of the event window, reset circuit 908 will be triggered and will reset each flip flop 902 to reset value 910.

In parallel, comparator 916 may determine whether a sufficient number of microcells have been triggered. In particular, comparator 916 may compare the number of microcells triggered (e.g., one microcell, two microcells, three microcells, or four microcells) to count value 914. If at least as many microcells as count value 914 have been triggered during the event window, comparator 916 may output event output 818. In this way, coincidence circuit 804 may determine that a threshold number of the microcells in the macropixel associated with coincidence circuit 804 are triggered within a given event window and therefore that the macropixel has been triggered during the event window. The use of coincidence circuit 804 may reduce background noise, as a single triggered microcell may be insufficient to trigger the associated macropixel.

Although FIGS. 7 and 8 have shown and described a coincidence circuit associated with each macropixel in a sensor array, this is merely illustrative. In some embodiments, each microcell of the sensor array may be individually reconfigurable, and the coincidence circuits may be omitted. Alternatively or additionally, MUX 802 and/or coincidence circuit 804 may be shared across multiple macropixels and/or microcells.

It will be recognized by one skilled in the art that the present exemplary embodiments may be practiced without some or all of these specific details. In other instances, well-known operations have not been described in detail in order not to unnecessarily obscure the present embodiments.

The foregoing is merely illustrative and various modifications can be made to the described embodiments. The foregoing embodiments may be implemented individually or in any combination.

What is claimed is:

1. A light detection and ranging device configured to measure a depth of an external object, the light detection and ranging device comprising:
a light source configured to emit light toward the external object; and
a sensor array comprising a plurality of single photon avalanche diode microcells configured to produce measurements in response to reflected light from the external object, wherein the single photon avalanche diode microcells are configured to be activated in reconfigurable columns of the single photon avalanche diode microcells.

2. The light detection and ranging device of claim 1, further comprising:
first optics that overlap the light source; and
second optics that overlap the sensor array, wherein the single photon avalanche diode microcells are configured to be activated in the reconfigurable columns based on the first optics and the second optics.

3. The light detection and ranging device of claim 2, wherein the single photon avalanche diode microcells are configured to be activated in the reconfigurable columns to coincide with distortion of the light emitted toward the external object by the first optics and the reflected light from the external object by the second optics.

4. The light detection and ranging device of claim 3, wherein the single photon avalanche diode microcells are further configured to be activated in the reconfigurable columns based on a distance between the external object and the sensor array.

5. The light detection and ranging device of claim 1, wherein the single photon avalanche diode microcells are arranged in macropixels, wherein the single photon avalanche diode microcells of a given macropixel have a shared output circuit, and the macropixels are configured to be activated in reconfigurable columns of the macropixels.

6. The light detection and ranging device of claim 5, wherein each of the macropixels comprises four of the single photon avalanche diode microcells.

7. The light detection and ranging device of claim 5, wherein the reflected light received by the sensor array is a distorted line of light, and the macropixels are configured to be activated in the reconfigurable columns to coincide with the distorted line of light.

8. The light detection and ranging device of claim 7, further comprising:
optics that overlap the light source and the sensor array, wherein the optics are configured to distort the light into the distorted line of light, and the macropixels are configured to be activated in the reconfigurable columns based on the optics.

9. The light detection and ranging device of claim 5, wherein the reconfigurable columns are configured to be adjusted on a microcell-level.

10. The light detection and ranging device of claim 5, further comprising:
a multiplexer coupled to each of the macropixels, wherein the multiplexer is configured to activate the reconfigurable columns.

11. The light detection and ranging device of claim 10, further comprising:
a coincidence circuit coupled to each of the multiplexers, wherein the coincidence circuit is configured to trigger an event in response to a threshold number of the microcells of the respective macropixel being activated within an event window.

12. A method of operating a light detection and ranging device, the method comprising:
emitting a line of laser light toward an external object with a light source; and
detecting a distorted line of light that has reflected from the external object using a reconfigurable column of single photon avalanche diode microcells in a sensor array.

13. The method of claim 12, wherein detecting the distorted line of light comprises detecting the distorted line of light using a column of the single photon avalanche diode microcells that coincides with the distorted line of light.

14. The method of claim 12, wherein detecting the distorted line of light comprising detecting the distorted line of light using a reconfigurable column of macropixels that each includes multiple single photon avalanche diode microcells.

15. The method of claim 14, wherein detecting the distorted line of light comprises detecting the distorted line of light using a column of the macropixels that coincides with the distorted line of light.

16. The method of claim 14, wherein detecting the distorted line of light comprises detecting the distorted line of light using a column of the macropixels that is reconfigured based on optics in the light detection and ranging device.

17. A sensor array configured to produce a time-of-flight measurement in response to an external object, the sensor array comprising:
an array of macropixels, wherein a reconfigurable column of the macropixels is configured to generate signals in response to a reflected line of light from the external object, and wherein the reconfigurable column of the macropixels is configured to be activated to coincide with the reflected line of light.

18. The sensor array of claim 17, wherein each of the macropixels comprises at least four single photon avalanche diode microcells.

19. The sensor array of claim 17, wherein each of the macropixels includes multiple microcells, the sensor array further comprising:
a multiplexer coupled to each of the macropixels, wherein the reconfigurable column of the macropixels is reconfigurable on a microcell-level.

20. The sensor array of claim 19, further comprising:
a coincidence circuit coupled to each of the multiplexers, wherein the coincidence circuit is configured to trigger an event in response to a threshold number of the microcells of the respective macropixel being activated within an event window.
